(19) United States
(12) Patent Application Publication
(10) Pub. No.: US 2004/0204084 A1
(43) Pub. Date: Oct. 14, 2004

(54) Telecommunication unit with wireless handset and plug-in wireless interface module

(76) Inventors: Chin-Hooi Tan, Bayan Lepas (MY); Che-Hung Chen, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/387,641

(22) Filed: Mar. 13, 2003

(51) Int. Cl. H04M 1/00

(52) U.S. Cl. 455/557; 455/550.1

(57) ABSTRACT

A telecommunication unit with wireless handset and plug-in wireless interface module is proposed, which allows a user to use a wireless handset to carry out a specific telephone function, such as PSTN (Public Switched Telephone Network), VoIP (Voice over Internet Protocol), or Internet-based telephone function. The proposed telecommunication unit is characterized by the provision of a plug-in wireless interface module to allow a user to optionally add a wireless telephone function to a telephone platform, so as to allow the user to use a wireless handset instead of a cable-connected handset to issue and receive phone calls. This feature allows the user to talk on phone while leaving the place where the telephone platform is installed. Moreover, the plug-in wireless interface module is easy and effortless to install, and thus represents a convenient and cost-effective solution to the need for a wireless telephone function on a telephone platform.

### BACKGROUND OF THE INVENTION

1. Field of the Invention

This invention relates to wireless telephony technology, and more particularly, to a telecommunication unit with wireless handset and plug-in wireless interface module, which allows a user to carry out a telephone function, such as PSTN (Public Switched Telephone Network), VoIP (Voice over Internet Protocol), or Internet-based telephone function, in a wireless manner by means of the wireless handset and the plug-in wireless interface module.

2. Description of Related Art

A telephone unit is a widely used telecommunication apparatus that allows a user to communicate via natural voice with another person situated at a remote site. Conventional telephone units are analog type that transmits voice signals in analog form over a PSTN (Public Switched Telephone Network) system. With the advent of digital and Internet technologies, users can now use a personal computer (PC) platform for digitized voice communication through the Internet with another PC or phone user linked to the Internet. In addition, a newer technology called VoIP (Voice over Internet Protocol) allows users to use a digital-type telephone unit that can be linked directly to the Internet to allow the user to issue and receive phone calls via the Internet.

One drawback to conventional PSTN, VoIP, or Internet-based telephone platforms, however, is that they are typically equipped with a cable-connected handset, which requires quires the user to be situated right beside the telephone platform when the user wants to talk on the phone, and wouldn't allow the user to talk on the phone on the go while leaving his/her office. A conventional solution to this problem is to provide a wireless-capable telephone unit with a wireless handset to allow the user to talk on the phone with the wireless handset at a distant site from where the telephone platform is installed

One drawback to the foregoing solution, however, is that the required wireless interface between the telephone platform and the wireless handset is fixedly integrated to the internal architecture of the telephone platform; and therefore, for those users who don't need wireless telephone function, the telephone manufacturer should provide a non-wireless model, which would considerably increase the overall cost of product development and manufacture. In addition, there is a need in the consumer market for a telephone platform that can be normally operated with a cable-connected handset, and when in need, allows the user to conveniently upgrade the telephone platform to include a wireless telephone function to allow the telephone platform to be operable with a wireless handset.

### SUMMARY OF THE INVENTION

It is therefore an objective of this invention to provide a telecommunication unit with wireless handset and plug-in wireless interface module, which allows a user to optionally add a wireless telephone function to the telephone platform, so as to allow the user to be able to talk on phone via a wireless handset while leaving the place where the telephone platform is installed.

It is another objective of this invention to provide a telecommunication unit with wireless handset and plug-in wireless interface module that can offer a convenient and cost-effective solution to the need for a wireless telephone function on a telephone platform.

The telecommunication unit with wireless handset and plug-in wireless interface module according to the invention is characterized by the provision of a plug-in wireless interface module to allow a user to optionally add a wireless telephone function to a telephone platform with a cable-connected handset, so as to allow the user to instead use a wireless handset to issue and receive phone calls via the telephone platform.

The foregoing feature of the invention allows the user to be nevertheless able to talk on phone while leaving the place where the telephone platform is installed, such as the user's office desk. Moreover, since the plug-in wireless interface module is easy and effortless to install, the invention provides a convenient and cost-effective solution to the need for a wireless telephone function on a telephone platform.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the telecommunication unit with wireless handset and plug-in wireless interface module according to the invention;

FIG. 2A is a schematic diagram showing an example of the telecommunication unit of the invention when the plug-in wireless interface module is unattached to the telephone platform; and

FIG. 2B shows the same of FIG. 2A except when the plug-in wireless interface module is attached to the telephone platform to provide a wireless telephone function for the telephone platform.

### DETAILED DESCRIPTION OF PREFERRED EMBODIMENTS

The telecommunication unit with wireless handset and plug-in wireless interface module according to the invention is disclosed in full details by way of preferred embodiments in the following with reference to the accompanying drawings.

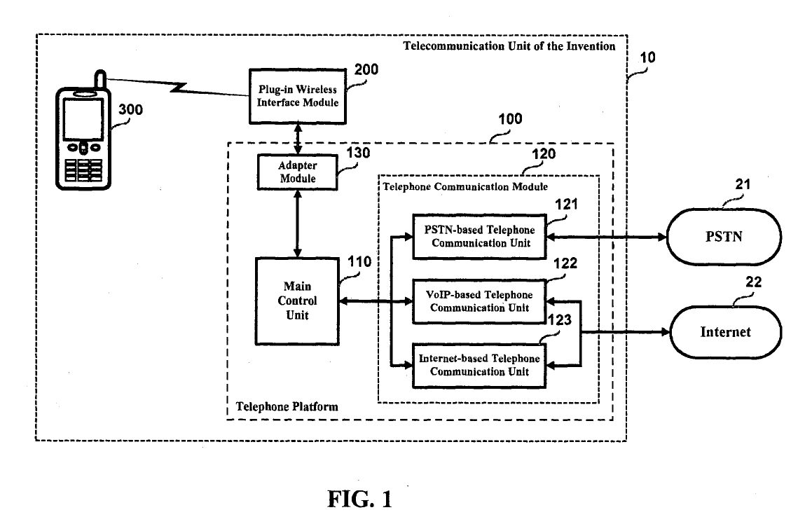

FIG. 1 is a schematic diagram showing the system architecture of the telecommunication unit with wireless handset and plug-in wireless interface module according to the invention (as the part enclosed in the dotted box indicated by the reference numeral 10). As shown, the telecommunication unit of the invention 10 is designed for connection to an existing voice data transmission system, such as the PSTN (Public Switched Telephone Network) system 21 and/or the Internet 22, and which is capable of providing either a PSTN-based telephone function, or a VoIP (Voice over Internet Protocol) based telephone function, or an Internet-based telephone function for the user. The telecommunication unit of the invention 10 can include all of these three telephone functions in one single unit, or selectively include only one or two of these three telephone functions in one single unit.

As shown in FIG. 1, the telecommunication unit of the invention 10 comprises: (a) a telephone platform 100; (b) a plug-in wireless interface module 200; and (c) a wireless handset 300; and wherein the internal architecture of the telephone platform 100 includes a main control unit 110, a telephone communication module 120, and an adapter module 130.

The main control unit 110 is used to control all the operational functions of the telephone platform 100 and the data exchange between the telephone communication module 120 and the plug-in wireless interface module 200 when the plug-in wireless interface module 200 is attached to the adapter module 130.

In the embodiment of FIG. 1, the telephone communication module 120 includes a PSTN-based telephone communication unit 121, a VoIP-based telephone communication unit 122, and an Internet-based telephone communication unit 123. Alternatively in other embodiments, the telephone communication module 120 can optionally include only one or two of these telephone communication units 121, 122,123 in one single unit. When two or more of these telephone communication units 121, 122, 123 are included, a switch means (not shown) should be provided for the user to select the desired telephone function. Since PSTN, VoIP, and Internet-based telephone functions are all well-known technology, details about the internal architecture of these three telephone communication units 121, 122, 123 will not be further described in this specification.

The adapter module 130 is a characterized component of the telecommunication unit of the invention 10, which is integrated to the internal architecture of the telephone platform 100, and which allows the plug-in wireless interface module 200 to be functionally coupled to the telephone platform 100 by attaching the plug-in wireless interface module 200 to the adapter module 130.

The plug-in wireless interface module 200 is another characterized component of the invention, which can be functionally coupled to the main control unit 110 inside the telephone platform 100 by attaching it to the adapter module 130 on the telephone platform 100. When the plug-in wireless interface module 200 is attached in position to the adapter module 130, a data exchange link is established between the plug-in wireless interface module 200 and the main control unit 110, thereby allowing the plug-in wireless interface module 200 to exchange voice data with the telephone communication module 120 via the main control unit 110. The functionality and internal architecture of the plug-in wireless interface module 200 is based on a standard wireless communication protocol, such as a cordless wireless communication protocol selected from the groups including DECT (Digital Enhanced Cordless Telecommunications), FHSS (Frequency-Hopping Spread Spectrum), DSSS (Direct-Sequence Spread Spectrum), WDCT (Worldwide Digital Cordless Telecommunications), PHS (Personal Handy Phone System), and so on; or a wireless LAN (Local Area Network) protocol, such as the IEEE 802.11 series (802.11a, 802.11b, 802.11g, etc.); or the Bluetooth protocol; to name just a few.

The wireless handset 300 is capable of establishing a wireless communication link with the plug-in wireless interface module 200 when the plug-in wireless interface module 200 is attached in position to the adapter module 130 on the telephone platform 100, allowing the user to use the wireless handset 300 to issue and receive PSTN, VoIP, or Internet-based phone calls by way of the telephone platform 100 to another person whose telephone unit (not shown) is also linked to the PSTN system 21 or the Internet 22.

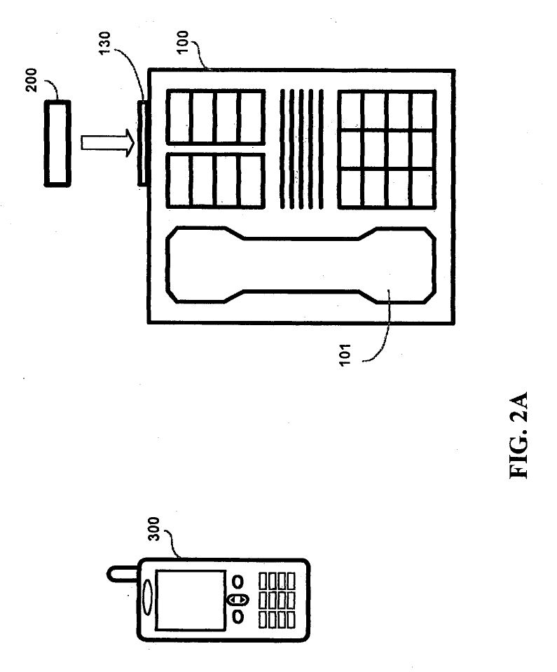

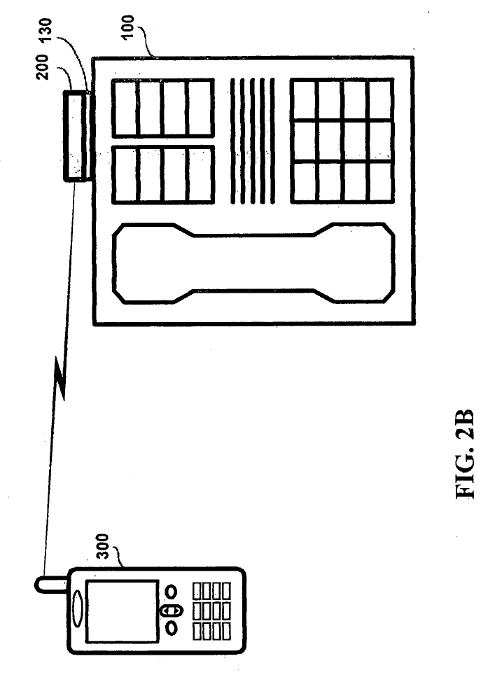

FIGS. 2A-2B are schematic diagrams showing an example of the telecommunication unit of the invention 10; wherein FIG. 2A shows the telecommunication unit of the invention 10 when the plug-in wireless interface module 200 is unattached to the telephone platform 100; while FIG. 2B shows the same of FIG. 2A except when the plug-in wireless interface module 200 is attached to the telephone platform 100.

As shown in FIG. 2A, in the utilization of the telephone platform 100, the user can normally use the cable-connected handset 101 on the telephone platform 100 to issue and receive phone calls via the PSTN system 21 or the Internet 22; and when wireless telephone function is desired, the user can purchase a plug-in wireless interface module 200 and attach the plug-in wireless interface module 200 to the adapter module 130 on the telephone platform 100. As further illustrated in FIG. 2B, when the plug-in wireless interface module 200 is attached in position on the telephone platform 100, it allows the user to use the wireless handset 300 instead of the cable-connected handset 101 to issue and receive PSTN, VoIP, or Internet-based phone calls via the telephone platform 100 in a wireless manner. During a wireless telephone session, the ongoing voice data are transmitted from the wireless handset 300 via the plug-in wireless interface module 200 to the telephone platform 100, and subsequently via the PSTN system 21 or the Internet 22 to the other side's telephone unit (not shown); and vice versa, the incoming voice data are transmitted from the other side's telephone unit (not shown) via the PSTN system 21 or the Internet 22 to the telephone platform 100, and subsequently via the plug-in wireless interface module 200 to the wireless handset 300.

In conclusion, the invention provides a telecommunication unit with wireless handset and plug-in wireless interface module, which is characterized by the provision of a plug-in wireless interface module to allow a user to optionally add a wireless telephone function to a telephone platform with a cable-connected handset, so as to allow the user to instead use a wireless handset to issue and receive phone calls via the telephone platform. This feature allows the user to be nevertheless able to talk on phone while leaving the place where the telephone platform is installed, such as the user's office desk. Moreover, since the plug-in wireless interface module is easy and effortless to install, the invention provides a convenient and cost-effective solution to the need for a wireless telephone function on a telephone platform.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A telecommunication unit, which comprises:
a telephone platform, which includes:
a main control unit for controlling data exchange within the telephone platform and operational functions of the telephone platform;
a telephone communication module, which is externally linked to a voice data transmission network system to provide a telephone function; and
an adapter module coupled to the main control unit;
a plug-in wireless interface module, which is externally connectable to the telephone platform by being attached to the adapter module to thereby establish a data exchange link with the telephone communication module via the main control unit within the telephone platform; and
a wireless handset, which is capable of establishing a wireless communication link with the plug-in wireless interface module to thereby link via the main control unit to the telephone communication module to allow a user to use the wireless handset to carry out a wireless telephone function via the telephone platform.

2. The telecommunication unit of claim 1, wherein the telephone communication module includes a PSTN-based telephone communication unit.

3. The telecommunication unit of claim 1, wherein the telephone communication module includes a VoIP-based telephone communication unit.

4. The telecommunication unit of claim 1, wherein the telephone communication module includes an Internet-based telephone communication unit.

5. The telecommunication unit of claim 1, wherein the plug-in wireless interface module is compliant with a standard cordless communication protocol.

6. The telecommunication unit of claim 5, wherein the plug-in wireless interface module is compliant with the DECT cordless communication protocol.

7. The telecommunication unit of claim 1, wherein the plug-in wireless interface module is compliant with the FUSS cordless communication protocol.

8. The telecommunication unit of claim 1, wherein the plug-in wireless interface module is compliant with the DSSS cordless communication-protocol.

9. The telecommunication unit of claim 1, wherein the plug-in wireless interface module is compliant with the WDCT cordless communication protocol.

10. The telecommunication unit of claim 1, wherein the plug-in wireless interface module is compliant with the PHS cordless communication protocol.

11. The telecommunication unit of claim 1, wherein the plug-in wireless interface module is compliant with the CT2 cordless communication protocol.

12. The telecommunication unit of claim 1, wherein the plug-in wireless interface module is compliant with a standard wireless LAN communication protocol.

13. The telecommunication unit of claim 12, wherein the plug-in wireless interface module is compliant with the IEEE 802.11 series communication protocol.

14. The telecommunication unit of claim 1, wherein the plug-in wireless interface module is compliant with the Bluetooth wireless communication protocol.
